(19) United States
(12) Patent Application Publication
(10) Pub. No.: US 2025/0038336 A1
(43) Pub. Date: Jan. 30, 2025

(54) CLIP FOR BATTERY ASSEMBLY

(71) Applicant: JAGUAR LAND ROVER LIMITED, Coventry (GB)

(72) Inventors: Niall SHIMMIN, Coventry (GB); Alex WATSON, Coventry (GB); Thomas MARSHALL, Stratford Upon Avon (GB)

(21) Appl. No.: 18/360,518

(22) Filed: Jul. 27, 2023

(51) Int. Cl. H01M 50/264; F16B 2/22; H01M 50/249

(52) U.S. Cl. CPC H01M 50/264; F16B 2/22; H01M 50/249; B60R 16/033; H01M 2220/20

(57) ABSTRACT

A clip for retaining a collar in position on a surface of a battery assembly during assembly of the battery assembly to a vehicle body component, wherein the collar is retained between the surface of the battery assembly and the vehicle body component when assembled to maintain a defined spacing therebetween. The clip comprises a mounting portion comprising a retaining stud releasably engageable with a corresponding hole in the surface of the battery assembly for retention of the clip on said surface. The clip also comprises a gripping portion configured to resiliently deflect as urged into engagement with an outer engagement surface of the collar to securely retain the collar therewithin.

### TECHNICAL FIELD

The present disclosure relates to a clip for retaining a collar in position on a battery assembly during assembly of the battery assembly to a vehicle body component, thereby maintaining a defined spacing therebetween when assembled. The present disclosure also relates to an assembly comprising the collar and the clip securely retained on the collar. In particular, but not exclusively, the clip is adapted to secure a high voltage battery to a vehicle component. Thus, in addition, the present disclosure relates to a vehicle comprising a body component and a battery, wherein the battery is secured to the body component with a spacing therebetween defined by the clip and the collar. The present disclosure also relates to methods of assembling a battery assembly to a vehicle body component with a spacing therebetween as defined by the collar as retained by the clip.

### BACKGROUND

High voltage batteries are incorporated into fully electric and hybrid vehicles as either a primary or secondary energy source.

It is an aim of the present invention to address one or more of the disadvantages associated with the prior art.

### SUMMARY OF THE INVENTION

Aspects and embodiments of the invention provide a clip for retaining a collar in position on a battery assembly during assembly of the battery assembly to a vehicle body component and a method of assembling a battery assembly to a vehicle body component. Aspects and embodiments of the invention also provide an assembly comprising the clip and a collar. Aspects and embodiments of the invention further provide a vehicle comprising a body component, a battery assembly, the collar, and the clip.

According to an aspect of the present invention there is provided a clip for retaining a collar in position on a surface of a battery assembly during assembly of the battery assembly to a vehicle body component, wherein the collar is retained between the surface of the battery assembly and the vehicle body component when assembled to maintain a defined spacing therebetween, the clip comprising: a mounting portion comprising at least one retaining stud releasably engageable with a corresponding hole in the surface of the battery assembly for retention of the clip on said surface; and a gripping portion configured to resiliently deflect as urged into engagement with an outer engagement surface of the collar to securely retain the collar therewithin. Retaining the collar in position through the gripping engagement with the clip and the releasable engagement with the battery assembly component is advantageous since the collar does not have to be welded in position to ensure the collar does not become misplaced during assembly. This dispenses of the need for expensive and bulky welding equipment and associated heat distortions. Furthermore, the assembly is easily dismounted, which facilitates subsequent servicing operations, especially providing ready access to cut the sealant layer.

Optionally the clip further comprises an axial passage therethrough to receive a fastener for securing the battery assembly to the vehicle body component.

The retaining stud may optionally include a resiliently deflectable finger, that is adapted to deflect on insertion into the hole for frictional engagement with an interior surface of the hole. A projection may optionally be included on the resiliently deflectable finger for snap-fit engagement with a corresponding ledge at the interior surface of the hole. In one example, the ledge may surround the hole.

In one example, first and second studs are provided on opposite sides of the mounting portion.

Optionally the gripping portion is substantially annular, resiliently deflectable outwardly to expand as urged into engagement with the outer engagement surface of the collar. The gripping portion may optionally comprise an annular series of fingers projecting away from mounting portion. The annular series of fingers may taper inwardly away from mounting portion.

According to a further aspect of the present invention there is provided an assembly comprising a collar and a clip as described above. In one example, the assembly further comprises the battery assembly, wherein the clip is securely releasably engaged with said surface of the battery assembly. The clip and collar may be pre-assembled prior to mounting the clip to the surface of the battery assembly. Alternatively, the clip may be mounted to the surface of the battery assembly separately: the clip may be mounted to the surface with the collar then being inserted into place within the clip; or the clip may be mounted to the surface by being passed over the collar in situ.

According to a still further aspect of the present invention there is provided a vehicle comprising: a body component; a battery assembly; a collar; and a clip as described above, wherein the clip is securely releasably engaged with a surface of the battery; wherein the battery is secured to the body component with a spacing therebetween defined by the collar.

According to another aspect of the present invention there is provided a method of mounting a battery assembly to a vehicle body component, the method comprising: placing a collar in position on a surface of the battery assembly; urging a clip around the collar towards said surface, so that a mounting portion of the clip comprising at least one retaining stud is brought into releasable engagement with a corresponding hole in said surface, whilst a gripping portion of the clip deflects as urged on to an outer engagement surface of the collar to securely retain the collar therewithin, thereby retaining the collar in position; and securing the battery assembly to the vehicle body component with a spacing therebetween as defined by the collar.

In some embodiments, the collar comprises an axial passage and placing the collar in position on said surface of the battery assembly comprises aligning the axial passage of the collar with a fastener hole through said surface. In such embodiments, securing the battery assembly to the vehicle body component may comprise inserting a releasable fastener through said fastener hole and through the axial passage of the collar. The releasable fastener may be further inserted into or through a corresponding hole in the vehicle body component.

Rather than first placing the collar in position on the surface and then pushing an associated clip over the collar into engagement with the surface, the clip can be mounted in position first with the collar then being inserted into the pre-mounted clip. This may be advantageous because the mounting of the clip to the surface is secure due to the frictional engagement of the retaining stud and the associated hole, and the collar is thus less likely to be dislodged or misplaced during the mounting procedure. Thus, according to another aspect of the present invention there is provided a method of mounting a battery assembly to a vehicle body component, the method comprising: placing a clip in position on a surface of the battery assembly so that a mounting portion of the clip comprising at least one retaining stud is brought into releasable engagement with a corresponding hole in said surface; urging a collar towards said surface into the clip, bringing an outer engagement surface of the collar into engagement with a gripping portion of the clip, whereby the gripping portion deflects to securely retain the collar therewithin, thereby retaining the collar in position on said surface; and securing the battery assembly to the vehicle body component with a spacing therebetween as defined by the collar.

In some embodiments, the collar comprises an axial passage and placing the clip in position on said surface of the battery assembly comprises aligning the clip with a fastener hole through said surface. In such embodiments, securing the battery assembly to the vehicle body component may comprise inserting a releasable fastener through said fastener hole and through the axial passage of the collar. The releasable fastener may be further inserted into or through a corresponding hole in the vehicle body component.

In another embodiment, the collar and associated clip can be pre-assembled prior to mounting as a unit in position on the surface. This may be advantageous to reduce the risk of the collars being misplaced or dislodged during the assembly process and may also lead to a faster, more convenient mounting procedure. Thus, according to another aspect of the present invention there is provided a method of mounting a battery assembly to a vehicle body component, the method comprising: urging a collar into a clip, bringing an outer engagement surface of the collar into engagement with a gripping portion of the clip, whereby the gripping portion deflects to securely retain the collar therewithin; placing the clip with retained collar in position on a surface of the battery assembly so that a mounting portion of the clip comprising at least one retaining stud is brought into releasable engagement with a corresponding hole in said surface, thereby retaining the collar in position on said surface; and securing the battery assembly to the vehicle body component with a spacing therebetween as defined by the collar.

In some embodiments, the collar comprises an axial passage and placing the clip with retained collar in position on said surface of the battery assembly comprises aligning the axial passage of the collar with a fastener hole through said surface. In such embodiments, securing the battery assembly to the vehicle body component comprises inserting a releasable fastener through said fastener hole and through the axial passage of the collar.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a cross-section through part of an exemplary battery assembly as mounted to a vehicle sill;

FIG. 2 shows an isometric view in partial cross-section taken through a portion of a battery assembly according to the invention.

FIG. 3 shows an enlarged view of a portion of FIG. 2;

FIG. 4 shows an isometric view in partial cross-section taken through a portion of a battery assembly according to the invention as mounted to a vehicle sill;

FIG. 5 shows an enlarged view of a portion of FIG. 4;

FIG. 6 shows a process diagram for a method of mounting a battery assembly to a vehicle body component according to one aspect of the invention

FIG. 7 shows a process diagram for a method of mounting a battery assembly to a vehicle body component according to another aspect of the invention; and

FIG. 8 shows a process diagram for a method of mounting a battery assembly to a vehicle body component according to another aspect of the invention.

### DETAILED DESCRIPTION

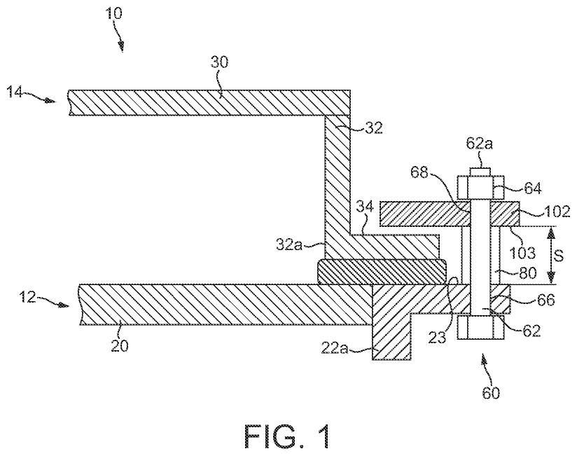

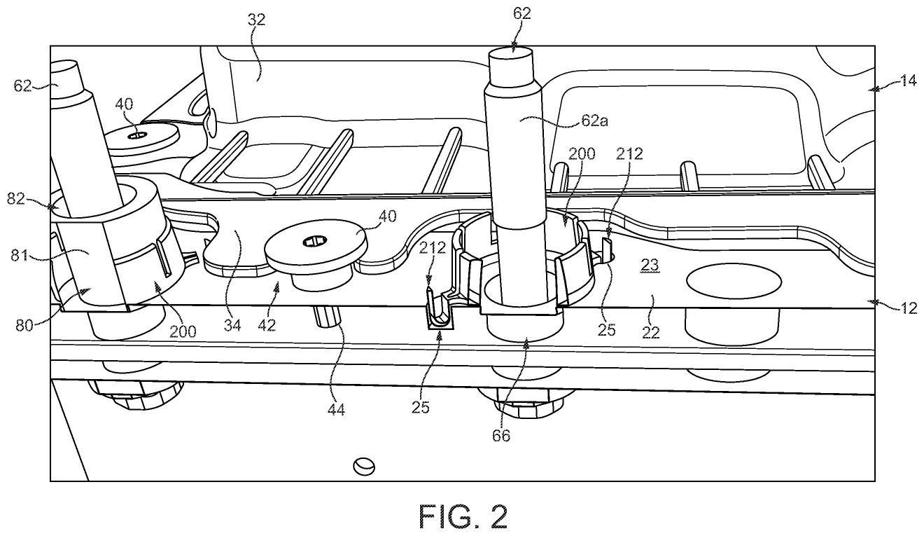

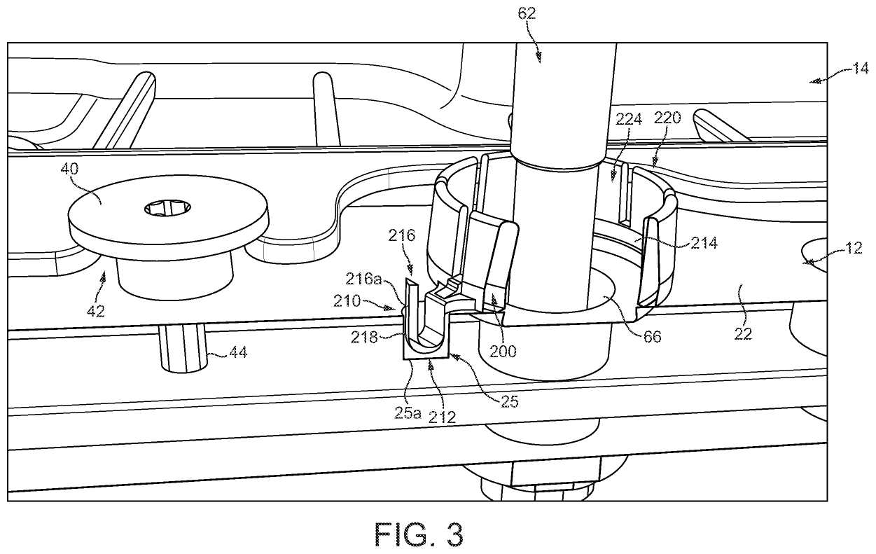

A high voltage battery assembly 10 typically comprises a base portion 12 and a lid portion 14, together defining a cavity 16 for receiving battery cells (not shown), as illustrated by reference to FIG. 1. The base portion 12 may comprise a substantially planar base plate 20 surrounded by a plurality of base frame members 22. The lid portion 14 typically comprises a substantially planar top portion 30, parallel to the base plate 20, and substantially vertical walls 32 extending downwardly therefrom towards the base plate. A flange or rim 34 extends outwardly from a bottom end 32a of the walls 32, circumscribing the bottom end of the lid portion 14. As seen in FIGS. 2 to 4, fasteners 40 secure the lid portion 14 to the base portion 12. In one example, top hat-shaped fasteners 40 are passed through openings 42 in the rim 34 of the lid portion 14 and are secured in the underlying base portion 12—for example in corresponding holes 44 of the base frame members 22. A layer of sealant 50 is sandwiched between the base portion 12 and the lid portion 14 in order to ensure the integrity of their affixation and to seal the cavity 16.

Such a high voltage battery assembly 10 may be releasably mounted to a vehicle (not shown), such as to body component 102—typically a sill, and may form part of the vehicle structure. A releasable mounting provides for ease of servicing and replacement of the battery assembly 10. One convenient mechanism for releasably mounting the battery assembly 10 to the body component 102 is to use threaded fasteners 60, such as bolts 62 and associated nuts 64, as shown in schematic form in the accompanying FIG. 1. Conventionally, this has been done by passing a series of bolts 62 through associated holes 66 in the base frame members 22. through corresponding holes 68 in the body component 102 (e.g. the sill) and threading a nut 64 on to the threaded end 62a of each bolt, torquing to specifications. A defined separation ‘S’ between a bottom surface 103 of the body component 102 and an upper surface 23 of the underlying base frame members 22 is necessary to provide space in which to accommodate, for example, the heads of the fasteners 40 securing the lid portion 14 to the base portion 12, manufacturing tolerances, panel overlaps, different thicknesses of the sealant layer 50, etc. Moreover, a certain separation S is required in order to allow access for a cutting tool to cut through the sealant layer during servicing operations. This defined separation S is ensured by placing collars 80 of defined height in the gap between the battery assembly 10 and the body component 102. These collars 80 are typically cylindrical, with an axial passage 82 therethrough through which the bolts 62 securing the battery assembly 10 to the body component 102 are passed. The collars 80 cannot be placed loose on the upper surface 23 of the battery assembly 10 during mounting thereof (aka ‘decking’) to the body component 102 because they could fall off or become misaligned. Thus, conventionally, the collars 80 have been welded in position with an interference fit to the corresponding holes 66 in the battery assembly-specifically in the through holes in the base frame members 22 that accommodate the fastening bolts 62.

However, welding the collars 80 into position has associated consequences. Providing the welding equipment and operators can be expensive and may take up space on the manufacturing line that may not be available. There may also not be the physical space available, for example due to the need to place the holes 66 close to an outer edge of the base frame members 22, to perform satisfactory welding operations. Moreover, welding adds significant amounts of heat into the structure, risking distortions. Furthermore, the required direct interference fit between the collars and the associated holes necessitates very tight tolerances in order to avoid deforming the local area and risking the perpendicularity of the collars 80. Another consequence of welding collars in position is that the installation is permanent. Thus, the collars cannot readily be removed and can present obstacles during subsequent servicing operations. By way of example, it may be required to cut the sealant layer in order to access the cavity of the battery assembly; cutting tools may be impeded by the collars.

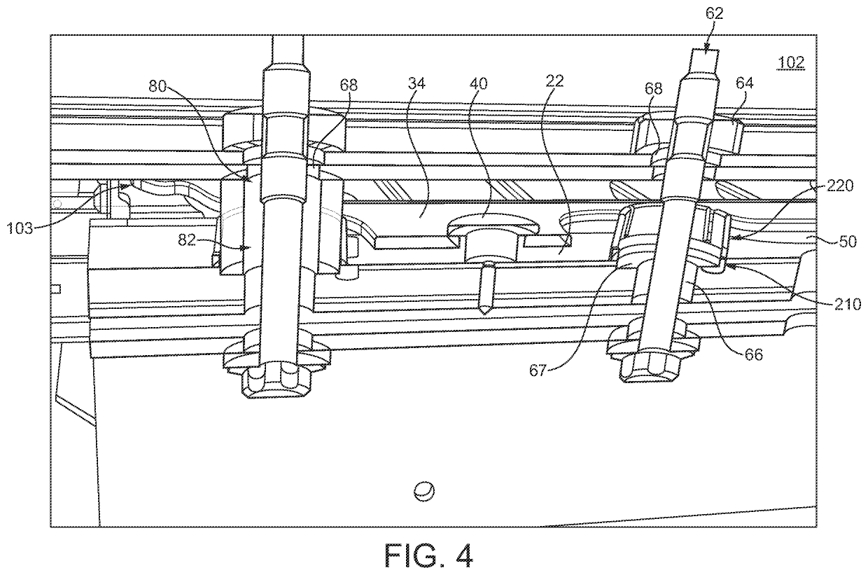

FIGS. 2 to 5 show a portion of a battery assembly 10 of the type generally illustrated in FIG. 1, but in which the collars 80 are each retained in position on the surface 23 of the base frame members 22 by a respective clip 200 rather than being welded in place. Two such clips 200 are shown in FIG. 2: the left-most clip 200 is shown in partial cross-section, engaged with a corresponding collar 80; whereas the right-most clip 200 is illustrated with the collar omitted, for clarity. Correspondingly, two such clips are also shown in FIG. 4, but here the collar 80 is omitted form the right-most clip 200.

Each clip 200 is generally annular in form and comprises a mounting portion 210 for retention of the clip on said surface 23, and a gripping portion 220 for engagement with the collar 80. The clip 200 may be formed by moulding a thermoplastic material. The collar 80 may be an extrusion, and may be formed of aluminium.

The mounting portion 210 comprises first and second retaining studs 212 projecting outwardly from opposed sides of a base ring 214 of the mounting portion. Each stud 212 is releasably engageable with a corresponding hole 25 in the surface 23 of a base frame member 22. The studs 212 releasably secure the clip 200 to the surface 23 by frictional engagement within the holes 25. To this end, each stud 212 may comprise a resiliently deflectable finger 216 that is adapted to deflect on insertion into the hole 25 for frictional engagement with an interior surface 25a of the hole 25. In certain examples, a projection 218 may be provided on the resiliently deflectable finger 216 for snap-fit engagement with a corresponding ledge (not shown) surrounding the interior surface 25a of the hole 25. The ledge may comprise an upper surface of a horizontal groove (not shown) in the interior surface 25a. When the studs 212 are fully inserted into the associated holes 25, the base ring 214 of the clip 200 bears flat against the surface 23 and a free end 216a of each resiliently deflectable finger 216 projects above the surface 23.

The holes 25 are located on the surface 23 such that when the clip 200 is in position with the studs 212 engaged in the holes 25, the clip 200 is concentrically aligned with an associated fastener hole 66 through the base frame member 22.

The gripping portion 220 is substantially annular, comprising an annular series of gripping fingers 222 integrally formed with and projecting away from mounting portion 210 in a direction opposed to the direction of projection of the studs 212—i.e. in use, when mounted in position on the surface 23, the studs 212 project into the surface whereas the gripping fingers 222 extend away from the surface 23. The annular series of gripping fingers 222 tapers inwardly away from mounting portion 210. The annular series of gripping fingers 222 and the base ring 214 together define an axial passage 224 through the clip 200 to receive a fastener in the form of a bolt 62 for securing the battery assembly 10 to the vehicle body component 102.

In use, a collar 80 is received within the gripping portion 220 by being pressed into engagement therewith such that the gripping fingers 222 resiliently deflect outwardly to expand as urged into engagement with an outer engagement surface 81 of the collar. When fully inserted, the collar 80 is thus securely retained within the gripping portion 220 by a frictional force. The resiliently deflectable fingers 222 provide a radial compressive force. It will be appreciated that other forms of gripping portion 220 could be used instead, provided that the collar is securely, and preferably releasably, retained within the gripping portion 220.

As illustrated, the collar 80 comprises a cylindrical member having a corresponding cylindrical outer surface 81 that is brought into engagement with inner faces of the gripping fingers 222, and an axially concentric passage 82 that allow passage of the associated bolt 62 therethrough. It will be understood that the collar 80 may take other forms instead, with corresponding modification to the profile of the gripping portion 220.

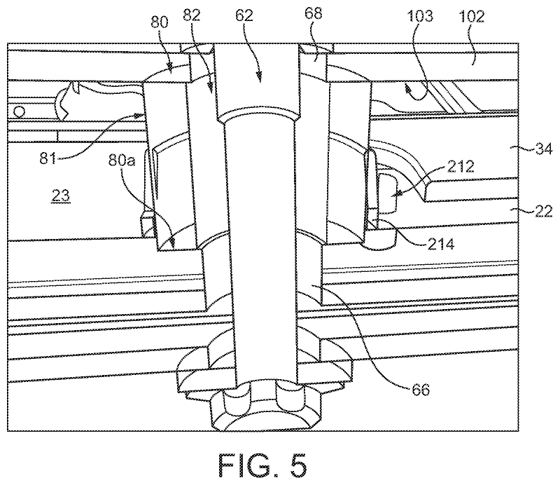

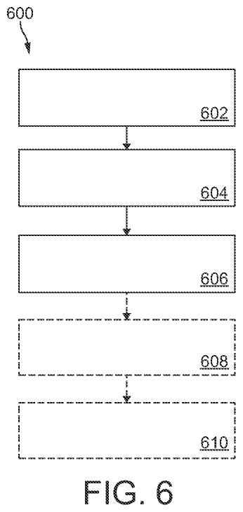

According to one method, as illustrated by reference to FIG. 6, a battery assembly 10 is mounted 600 to a vehicle body component such as a sill 102, by first placing 602 a collar 80 in position on the surface 23 of the battery assembly 10, with the axial passage 82 substantially aligned with a corresponding fastener hole 66, then pushing 604 an associated clip 200 around the collar 80 towards said surface 23, so that the studs 212 of the mounting portion 210 of the clip are brought into releasable engagement with the corresponding holes 25 in said surface, whilst the gripping portion 220 of the clip deflects as urged on to the outer engagement surface 81 of the collar to securely retain the collar therewithin, thereby retaining the collar in position. As described above, the base ring 214 bears against the surface 23. When fully inserted, a bottom face 80a of the collar 80 also bears against that surface 23. In certain embodiments, as illustrated for example in FIGS. 4 and 5, the surface may be stepped around the fastener hole 66, whereby a portion of the hole 66 adjacent the surface 23 includes a wider diameter section defining an open-ended recess 67 to receive the bottom face 80a of the collar 80.

Once the collar 80 and associated clip 200 are securely retained in position on the battery assembly 10, the battery assembly can be secured 606 to the vehicle body component 102. This may be done by inserting 608 a releasable fastener 60 in the form of a bolt 62 through said fastener hole 66 and through the axial passage 82 of the collar. The bolt 62 is further inserted through a corresponding hole 68 through the vehicle body component 102, and a nut 64 is threaded 610 on to a corresponding threaded end of the bolt 62 and torqued to specification. Alternatively, the hole 68 in the vehicle body component could be a threaded hole and the nut 64 could be omitted.

A plurality of fasteners 60 is typically used to secure the battery assembly 10 to the vehicle body component 102, and each such fastener would be passed through an associated fastener hole 66 onward to a corresponding hole 64 in the vehicle body component. An associated clip 200 and collar 80 may be employed at each such fastener 60.

The spacing S between the surface 23 of the battery assembly 10 and the associated surface 103 of the vehicle body component 102 is defined by the height of the or each collar 80.

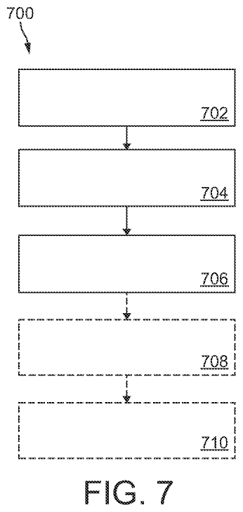

According to another method 700, as illustrated by reference to FIG. 7, rather than first placing the collar 80 in position on the surface 23 and then pushing the associated clip 200 over the collar into engagement with the surface, the clip 200 is mounted in position first with the collar 80 then being inserted into the pre-mounted clip 200. Thus, a clip 200 is placed 702 in position on the surface 23 of the battery assembly 10 so that the studs 212 of the mounting portion 210 of the clip are brought into releasable engagement with the corresponding holes 25 in said surface and the base ring 214 bears against the surface. Due to the location of the holes 25, the axial passage 224 through the clip 200 is thus aligned with a corresponding fastener hole 66. A collar 80 is then urged 704 towards said surface 23 into the clip 200, bringing the outer engagement surface 81 of the collar into engagement with the gripping portion 220 of the clip, whereby the gripping portion, and specifically the resiliently deflectable fingers 222 thereof, deflects to securely retain the collar 80 therewithin. Once fully inserted, the bottom face 80a of the collar 80 bears against the surface 23, and the axial passage 82 therethrough is in alignment with the fastener hole 66. The collar 80 is thus retained in position on the surface 23.

Once the collar 80 and associated clip 200 are securely retained in position on the battery assembly 10, the battery assembly can be secured 706 to the vehicle body component 102. This may be achieved by inserting 708 a bolt 62 through said fastener hole 66 and through the axial passage 82 of the collar, and threading 710 an associated nut 64 on to the bolt 62, as described above.

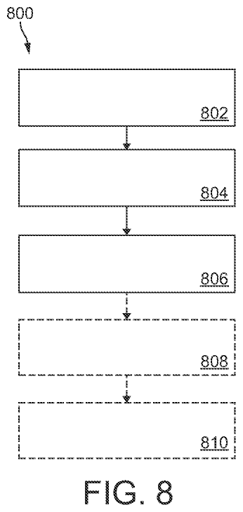

In another embodiment, as illustrated by reference to FIG. 8, a battery assembly 10 is mounted 800 to a vehicle body component 102 by pre-assembling the collar 80 and associated clip 200 prior to mounting as a unit in position on the surface 23. Thus, a collar 80 is first urged 802 into engagement with a corresponding clip 200, bringing the outer engagement surface 81 of the collar into engagement with the gripping portion 220 of the clip, and causing the gripping portion, specifically the deflectable fingers 222 thereof to deflect to securely retain the collar 80 therewithin with frictional engagement. Then, the clip 200 with retained collar 80 is placed 804 in position on the surface 23 of the battery assembly 10 as a unit, so that the studs 212 of the mounting portion 210 of the clip are brought into releasable engagement with the corresponding holes 25 in said surface and the base ring 214 bears against the surface. The bottom face 80a of the collar is concurrently brought to bear against the surface 23. Due to the location of the holes 25, the axial passage 224 through the clip 200 and the axial passage 82 through the collar are thus aligned with a corresponding fastener hole 66. The collar 80 is thus retained in position on the surface 23.

Once the collar 80 and associated clip 200 are securely retained in position on the battery assembly 10, the battery assembly can be secured 806 to the vehicle body component 102 by inserting 808 a bolt 62 through said fastener hole 66 and through the axial passage 82 of the collar, and threading 810 an associated nut 64 on to the bolt 62, as described above.

The battery assembly 10 can be dismounted from the vehicle body component 102 following a reverse procedure of releasing the releasable fasteners 60, for example for servicing of the battery assembly 10. Once servicing procedure, as described above, includes cutting the sealant layer 50 in order to enable the lid portion 30 to be removed from the base portion 20. Having the collars 80 in position on the surface 23 of the battery assembly could interfere with that cutting process, for example impeding access for cutting tools. Accordingly, the collars 80 can be dismounted from the surface 23 following a reverse process of the assembly steps outlined above. For example, the clip 200 associated with a collar 80 can be dismounted by pulling the clip 200 away from the surface 23, disengaging the mounting portion 210 and specifically the studs 212 from their associated holes 25. Particularly where the studs 212 are retained by a snap-fit engagement against a ledge, the free ends 216a of the fingers 216 may be squeezed towards each other to release the engagement.

It will be understood that in certain examples a single stud 212 and associated hole 25 may be provided, and that in other examples more than two studs 212 and associated holes 25 may be provided instead. However, a pair of opposed studs 212 may be beneficial in permitting a simple squeeze action between a user's fingers (such as a thumb and a finger of a single hand) to release the engagement of the clip 200 from the holes 25 for removal from the surface 23.

Whereas the clips 200 and associated collars 80 have been described in the context of mounting a battery assembly to a vehicle component it will be understood that the concept could be applied more broadly to assembling any sub-assembly to a vehicle component with a defined spacing, or, more broadly still, to the mounting of any first component to a second component with such a defined spacing therebetween.

It will be appreciated that various changes and modifications can be made to the present invention without departing from the scope of the present application.

1. A clip for retaining a collar in position on a surface of a battery assembly during assembly of the battery assembly to a vehicle body component, wherein the collar is retained between the surface of the battery assembly and the vehicle body component when assembled to maintain a defined spacing therebetween, the clip comprising:
a mounting portion comprising at least one retaining stud releasably engageable with a corresponding hole in the surface of the battery assembly for retention of the clip on said surface; and
a gripping portion configured to resiliently deflect as urged into engagement with an outer engagement surface of the collar to securely retain the collar therewithin.

2. The clip as claimed in claim 1, further comprising an axial passage therethrough to receive a fastener for securing the battery assembly to the vehicle body component.

3. The clip as claimed in claim 1, wherein the at least one retaining stud includes a resiliently deflectable finger that is adapted to deflect on insertion into the corresponding hole for frictional engagement with an interior surface of the corresponding hole.

4. The clip as claimed in claim 3, further comprising a projection on the resiliently deflectable finger for snap-fit engagement with a corresponding ledge at the interior surface of the corresponding hole.

5. The clip as claimed in claim 1, further comprising first and second studs on opposite sides of the mounting portion.

6. The clip as claimed in claim 1, wherein the gripping portion is substantially annular, resiliently deflectable outwardly to expand as urged into engagement with the outer engagement surface of the collar.

7. The clip as claimed in claim 6, wherein the gripping portion comprises an annular series of fingers projecting away from mounting portion.

8. The clip as claimed claim 7, wherein the annular series of fingers tapers inwardly away from mounting portion.

9. An assembly, comprising:
a collar; and
the clip as claimed in claim 1 securely retained on the collar.

10. The assembly as claimed in claim 9, further comprising the battery assembly, wherein the clip is securely releasably engaged with said surface of the battery assembly.

11. A vehicle, comprising:
a body component;
a battery assembly;
a collar; and
the clip as claimed in claim 1, wherein the clip is securely releasably engaged with a surface of the battery assembly;
wherein the battery assembly is secured to the body component with a spacing therebetween defined by the collar.

12. A method of mounting a battery assembly to a vehicle body component, the method comprising:
placing a collar in position on a surface of the battery assembly;
urging a clip around the collar towards said surface, so that a mounting portion of the clip comprising at least one retaining stud is brought into releasable engagement with a corresponding hole in said surface, whilst a gripping portion of the clip deflects as urged on to an outer engagement surface of the collar to securely retain the collar therewithin, thereby retaining the collar in position; and
securing the battery assembly to the vehicle body component with a spacing therebetween as defined by the collar.

13. The method as claimed in claim 12, wherein the collar comprises an axial passage and wherein placing the collar in position on said surface of the battery assembly comprises aligning the axial passage of the collar with a fastener hole through said surface.

14. The method as claimed in claim 13, wherein securing the battery assembly to the vehicle body component comprises inserting a releasable fastener through said fastener hole and through the axial passage of the collar.

15. A method of mounting a battery assembly to a vehicle body component, the method comprising:
placing a clip in position on a surface of the battery assembly so that a mounting portion of the clip comprising at least one retaining stud is brought into releasable engagement with a corresponding hole in said surface;
urging a collar towards said surface into the clip, bringing an outer engagement surface of the collar into engagement with a gripping portion of the clip, whereby the gripping portion deflects to securely retain the collar therewithin, thereby retaining the collar in position on said surface; and
securing the battery assembly to the vehicle body component with a spacing therebetween as defined by the collar.

16. The method as claimed in claim 15, wherein the collar comprises an axial passage and wherein placing the clip in position on said surface of the battery assembly comprises aligning the clip with a fastener hole through said surface.

17. The method as claimed in claim 16, wherein securing the battery assembly to the vehicle body component comprises inserting a releasable fastener through said fastener hole and through the axial passage of the collar.

18. A method of mounting a battery assembly to a vehicle body component, the method comprising:
urging a collar into a clip, bringing an outer engagement surface of the collar into engagement with a gripping portion of the clip, whereby the gripping portion deflects to securely retain the collar therewithin;
placing the clip with retained collar in position on a surface of the battery assembly so that a mounting portion of the clip comprising at least one retaining stud is brought into releasable engagement with a corresponding hole in said surface, thereby retaining the collar in position on said surface; and
securing the battery assembly to the vehicle body component with a spacing therebetween as defined by the collar.

19. The method as claimed in claim 18, wherein the collar comprises an axial passage and wherein placing the clip with retained collar in position on said surface of the battery assembly comprises aligning the axial passage of the collar with a fastener hole through said surface.

20. The method as claimed in claim 19, wherein securing the battery assembly to the vehicle body component comprises inserting a releasable fastener through said fastener hole and through the axial passage of the collar.
